(19) United States
(12) Patent Application Publication
(10) Pub. No.: US 2026/0327359 A1
(43) Pub. Date: Oct. 22, 2026

(54) UV-CURABLE PROTECTIVE FILM

(71) Applicant: 3M INNOVATIVE PROPERTIES COMPANY, St. Paul, MN (US)

(72) Inventors: Jong Seob Won, Gyeonggi-do (KR); Jihwan Jang, Gyeonggi-do (KR); Kyung Hwan Yoon, Gyeonggi-do (KR)

(21) Appl. No.: 19/486,736

(22) PCT Filed: May 20, 2024
(86) PCT No.: PCT/IB2024/054904

§ 371 Date: Nov. 24, 2025

Related U.S. Application Data
(60) Provisional application No. 63/472,030, filed on Jun. 9, 2023.

(51) Int. Cl. C08F 220/18; B41M 5/00; B41M 5/52; C08F 2/50; C09D 4/00

(52) U.S. Cl. CPC C08F 220/1811; B41M 5/007; B41M 5/5209; C08F 2/50; C09D 4/00

(57) ABSTRACT

In some embodiments, the curable composition comprises at least one high Tg alkyl (meth)acrylate having a homopolymer Tg of at least 60°C that is free of polar 5 groups, at least one low Tg alkyl (meth)acrylate having a homopolymer Tg of less than −30°C that is free of polar groups, at least one crosslinker; and at least one photoinitiator. The curable composition is solvent-free and inkjet printable having a viscosity of less than 25 centipoise at room temperature, and upon curing to form a coating of 100 micrometer thickness has a Tg of at least 50°C as measured by DMA (Dynamic Mechanical Analysis), 0 an adhesion to glass of less than 20 grams/inch (7.7 N/m) as measured by 180° Peel Adhesion, a Youngs modulus of greater than 0.5 GigaPascals, and is optically transparent.

### SUMMARY

Disclosed herein are curable compositions, articles prepared from the curable compositions, and methods of forming articles. The curable compositions may be ink compositions as the curable compositions are inkjet printable.

In some embodiments, the curable composition comprises at least one high Tg alkyl (meth)acrylate having a homopolymer Tg of at least 60 °C that is free of polar groups, at least one low Tg alkyl (meth)acrylate having a homopolymer Tg of less than-30 °C that is free of polar groups, at least one crosslinker; and at least one photoinitiator. The curable composition is solvent-free and inkjet printable having a viscosity of less than 25 centipoise at room temperature, and upon curing to form a coating of 100 micrometer thickness has a Tg of at least 50 °C as measured by DMA (Dynamic Mechanical Analysis), an adhesion to glass of less than 20 grams/inch (7.7 N/m) as measured by 180° Peel Adhesion, a Youngs modulus of greater than 0.5 GigaPascals, and is optically transparent.

Also disclosed are articles. In some embodiments, the articles comprise a substrate such as glass, and a cured coating disposed on at least a portion of the surface of the substrate. The cured coating comprises the curable coating composition described above that has been coated and cured. Methods for preparing the articles are also disclosed.

### DETAILED DESCRIPTION

A wide variety of optical and electronic devices have surfaces that require protective layers. Typically, these protective layers have strict optical requirements, such as being optically clear. The protective layers provide protection from scratches and fractures and also prevent contamination from adversely affecting the surface. Currently protective articles such as a PET (polyethylene terephthalate) film with PSA (pressure sensitive adhesive) coatings are used. These articles are laminated to the surface to protect them.

Among the new articles that require protective films are articles with surfaces that have an unusual size or shape and therefore, attachment of protective film articles can be problematic. Making film articles that are of the proper shape and size requires cutting of the film to fit the desired surface to be protected. The films can be cut prior to lamination or after lamination. Cutting to fit the surface can be difficult, time consuming and expensive. Additionally, since the film articles include an adhesive layer and a film layer, the articles are laminated to the surface of the articles. While lamination is a very useful process, it can be problematic for large surface area articles and also for articles with unusual shapes where optical clarity is required. Lamination defects such as bubbles, wrinkles, tears and the like become more likely with the lamination of larger film articles. Therefore, a method of preparing a protective film without having to pre- or post-configure the film to fit a surface is desirable. Additionally, adhering a protective film a surface without using a lamination process is also desirable.

A suitable alternative to laminating a film/PSA article to the surface a device to protect the surface is to coat a curable composition onto the surface and cure the composition to form a protective layer. However, there are also issues with many conventional coating techniques, issues similar to those described above with films in that it can be difficult to coat with precision onto surfaces with unusual shapes or sizes.

One particularly precise coating technique is inkjet printing. Not only is inkjet printing precise, it permits the delivery of a curable composition to a surface without touching the surface and therefore is suitable for a wide range of surfaces including those susceptible to damage by other techniques.

However, in replacing a film article by inkjet printing and curing a curable coating, there are a number of properties that must be met. Since the coating is being used in place of an adhesive/film article, the cured coating has to have similar properties as a protective film article as far as modulus and toughness. Additionally, like a PSA article, the cured coating has to be removable from the surface with damaging the surface or leaving residue. Finally, in order to be useful, the curable composition has to be inkjet printable, meaning it has to have, among other properties, a low viscosity. The curable composition has to be curable by the input of light without the need to provide heat and desirably cures quickly enough for rapid processing.

Disclosed herein are inkjet printable curable compositions that have this balance of properties required to form protective layers on device surfaces. Besides being inkjet printable and UV curable, among the properties are optical transparency to permit inspection of the protected surface, easily removable without damaging the surface, desirable mechanical properties. Typically, easy removability is a layer with an adhesive strength of no greater than 20 grams/inch (7.7 N/m) as measured by 180° Peel Adhesion. Desirable mechanical properties include properties that are similar to a conventional plastic film such as a relatively high modulus and toughness.

In some embodiments, the inkjet printable curable compositions comprise at least one high Tg alkyl (meth)acrylate having a homopolymer Tg of at least 60 °C that is free of polar groups, at least one low Tg alkyl (meth)acrylate having a homopolymer Tg of less than-30 °C that is free of polar groups, at least one crosslinker, and at least one photoinitiator. The curable composition is solvent-free and inkjet printable having a viscosity of less than 25 centipoise at room temperature. Upon curing to form a coating of 100 micrometer thickness the cured composition has a Tg of at least 50 °C as measured by DMA (Dynamic Mechanical Analysis), an adhesive to glass of less than 20 grams/inch (7.7 N/m) as measured by 180° Peel Adhesion, a Youngs modulus of greater than 0.5 GigaPascals, and is optically transparent.

Also disclosed herein are articles containing layers of the cured inkjet printable curable compositions and methods of preparing such articles.

The term “(meth)acrylate” refers to monomeric acrylic or methacrylic esters of alcohols. Acrylate and methacrylate monomers or oligomers are referred to collectively herein as “(meth)acrylates”. Materials referred to as “(meth)acrylate functional” are materials that contain one or more (meth)acrylate groups.

The term “silicone” and “siloxane” are used interchangeably and refer to units with dialkyl or diaryl siloxane (—SiR₂O—) repeating units.

The terms “room temperature” and “ambient temperature” are used interchangeably to mean temperatures in the range of 20 °C to 25 °C.

The terms “Tg” and “glass transition temperature” are used interchangeably. If measured, Tg values are determined by Dynamic Mechanical Analysis (DMA) at 1 Hz unless otherwise stated. Typically, Tg values for copolymers are not measured but are calculated using the well-known Fox Equation, using the monomer homopolymer Tg values provided by the monomer supplier, as is understood by one of skill in the art.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene often has 1 to 20 carbon atoms. In some embodiments, the alkylene contains 1 to 18, 1 to 12, 1 to 10, 1 to 8, 1 to 6, or 1 to 4 carbon atoms. The radical centers of the alkylene can be on the same carbon atom (i.e., an alkylidene) or on different carbon atoms.

The terms “free radically polymerizable” and “ethylenically unsaturated” are used interchangeably and refer to a reactive group which contains a carbon-carbon double bond which is able to be polymerized via a free radical polymerization mechanism.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 80% and a haze of less than 10%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 90%.

Disclosed herein are curable compositions that are printable, and thus are described as inks. The curable compositions need not be used as inks, that is to say that they need not be printed and then cured, the curable compositions can be delivered to substrate surfaces in a wide variety of ways, but they are capable of being printed, in particular they are capable of being inkjet printed, which means that they have the proper viscosity and other attributes to be inkjet printed. The term “inkjet printable” is not a process description or limitation, but rather is a material description, meaning that the curable compositions are capable of being inkjet printed, and not that the compositions necessarily have been inkjet printed. This is akin to the expression hot melt processable, which means that a composition is capable of being hot melt processed but does not mean that the composition has been hot melt processed.

In some embodiments, the curable composition comprises at least one high Tg alkyl (meth)acrylate having a homopolymer Tg of at least 60 °C that is free of polar groups, at least one low Tg alkyl (meth)acrylate having a homopolymer Tg of less than-30 °C that is free of polar groups, at least one crosslinker, and at least one photoinitiator. The curable composition is solvent-free and inkjet printable having a viscosity of less than 25 centipoise at room temperature. Upon curing to form a coating of 100 micrometer thickness, the curable composition has a Tg of at least 50 °C as measured by DMA (Dynamic Mechanical Analysis), an adhesion to glass of less than 20 grams/inch (7.7 N/m) as measured by 180° Peel Adhesion, a Youngs modulus of greater than 0.5 GigaPascals, and is optically transparent. In some embodiments, the coating may be optically clear.

A wide variety of (meth)acrylates are suitable for the at least one high Tg alkyl (meth)acrylate having a homopolymer Tg of at least 60 °C that is free of polar groups. In some embodiments, the high Tg alkyl (meth)acrylate comprises a compound of Formula 1,

CH₂═CR¹—(CO)—OR² Formula 1

where R¹ is hydrogen or a methyl group; —(CO)— is a carbonyl group C═O; and R² is an alkyl group comprising at least 8 carbon atoms; and is free from polar groups.

In some embodiments, the at least one high Tg alkyl (meth)acrylate comprises a compound of Formula 1,

CH₂═CR¹—(CO)—OR² Formula 1

where R¹ is hydrogen or a methyl group; —(CO)— is a carbonyl group C═O; and R² is a cyclic alkyl group comprising 10 carbon atoms.

Examples of suitable high Tg alkyl (meth)acrylates having a homopolymer Tg of at least 60 °C that is free of polar groups include dicyclopentanyl (meth)acrylate, isobornyl (meth)acrylate, dicyclopentanyl (meth)acrylate, and 4-tertbutylcyclohexyl (meth)acrylate.

The curable composition also comprises at least one low Tg alkyl (meth)acrylate having a Tg of less than-30 °C that is free of polar groups. In some embodiments, the low Tg (meth)acrylate comprises a compound of Formula 2,

CH₂═CR¹—(CO)—OR³ Formula 2

where R¹ is hydrogen or a methyl group; —(CO)— is a carbonyl group C═O; and R³ is an alkyl group comprising at least 4 carbon atoms; and is free from polar groups.

In some embodiments, the at least one low Tg alkyl (meth)acrylate comprises a compound of Formula 2,

CH₂═CR¹—(CO)—OR³ Formula 2

where R¹ is hydrogen or a methyl group; —(CO)— is a carbonyl group C═O; and R³ is a cyclic alkyl group comprising 8 carbon atoms.

Examples of suitable low Tg alkyl (meth)acrylates having a homopolymer Tg of less than −30 °C that is free of polar groups include butyl acrylate, 2-ethylhexyl acrylate, iso-octyl acrylate, n-hexyl acrylate, n-octyl acrylate, lauryl acrylate, behenyl acrylate, stearyl acrylate, hexadecyl acrylate, and heptadecyl acrylate.

The curable composition further comprises at least one crosslinker. Crosslinkers are well understood in the polymer arts as polyfunctional molecules that link polymer chains together. In the present curable ink compositions, the crosslinker typically is a multifunctional (meth)acrylate.

A wide range of crosslinkers are suitable. In some embodiments, the crosslinker comprises a di-(meth)acrylate of Formula 3:

CH₂═CR¹—(CO)—O—R⁴—O—(CO)—CR¹═CH₂ Formula 3

where R¹ is hydrogen or a methyl group; —(CO)— is a carbonyl group C═O; and R⁴ is an alkylene group with 4-10 carbon atoms.

Examples of useful multifunctional (meth)acrylate include, but are not limited to, butanediol di(meth)acrylate, hexanediol di(meth)acrylate, octanediol di(meth)acrylate, decanediol di(meth)acrylate, and mixtures thereof.

The curable composition further comprises at least one initiator. Typically, the initiator is a photoinitiator, meaning that the initiator is activated by light, generally ultraviolet (UV) light, although other light sources could be used with the appropriate choice of initiator, such as visible light initiators, infrared light initiators, and the like. Thus, the curable ink compositions are generally curable by UV or visible light, typically UV light. Therefore, typically, UV photoinitiators are used as the initiator. Photoinitiators are well understood by one of skill in the art of (meth)acrylate polymerization. Examples of suitable free radical photoinitiators include IRGACURE 4265, IRGACURE 184, IRGACURE 651, IRGACURE 1173, IRGACURE 819, IRGACURE TPO, IRGACURE TPO-L, commercially available from BASF, Charlotte, NC.

The curable coating composition may contain additional additives as long as the additives do not interfere with the coating, curing or final properties of the curable coating composition. In some embodiments, the curable coating composition further comprises at least one surfactant or wetting agent additive comprising a silicone-acrylate. Particularly suitable are the silicone polyetheracrylates commercially available from Evonik Industries under the trade name TEGO RAD, such as TEGO RAD 2100, TEGO RAD 2250, and TEGO RAD 2300. TEGO RAD 2250 is particularly suitable.

The amount of each component in the curable compositions may vary. In some embodiments, the curable composition comprises:
60-80 parts by weight of at least one high Tg alkyl (meth)acrylate having a homopolymer Tg of at least 60 °C that is free of polar groups;
20-40 parts by weight of at least one low Tg alkyl (meth)acrylate having a homopolymer Tg of less than-30 °C that is free of polar groups;
5-30 parts by weight of at least one crosslinker; and
0.1-5 parts by weight of at least one photoinitiator.

Each of these components is described in detail above.

In some embodiments, the curable composition further comprises:
0.1-1 parts by weight of at least one silicone-acrylate wetting agent.

Also disclosed herein are articles. In some embodiments, the article comprises a substrate with a first major surface and a second major surface, and a cured coating disposed on at least a portion of the second major surface of the substrate. The cured coating comprises a curable coating composition that has been coated and cured. The curable coating composition has been described above and comprises at least one high Tg alkyl (meth)acrylate having a homopolymer Tg of at least 60 °C that is free of polar groups, at least one low Tg alkyl (meth)acrylate having a homopolymer Tg of less than-30 °C that is free of polar groups, at least one crosslinker, and at least one photoinitiator. The curable composition is solvent-free and inkjet printable having a viscosity of less than 25 centipoise at room temperature, and upon curing to form a coating of 100 micrometer thickness the curable composition has a Tg of at least 50 °C as measured by DMA (Dynamic Mechanical Analysis), an adhesion to glass of less than 20 grams/inch (7.7 N/m), a Youngs modulus of greater than 0.5 GigaPascals, and is optically transparent. In some embodiments, the coating is optically clear. In some embodiments, the curable coating composition further comprises at least one wetting agent additive comprising a silicone-acrylate.

The articles comprise a substrate with a first major surface and a second major surface. The substrate is typically optically clear. Examples of suitable substrates include glass plates and plates of polymeric materials such as PMMA (polymethylmethacrylate) and PC (polycarbonate). Glass is a particularly suitable substrate.

In many embodiments, the curable coating has been inkjet printed onto the second major surface of the substrate and photocured to form the cured coating. Inkjet printing and photocuring are well understood processes in the polymeric arts.

The coating layer may have a variety of thicknesses. In some embodiments, the coating layer has a thickness of from 25-500 micrometers.

Also disclosed are methods of forming articles. In some embodiments, the method comprises providing a substrate with a first major surface and a second major surface, providing a curable coating composition. inkjet printing the curable coating composition onto the second major surface of the substrate, and photocuring the curable coating composition to form a coating layer on the second major surface of the substrate.

Suitable substrates and curable coating compositions are described in detail above. In some embodiments, the substrate comprises glass and the curable coating composition comprises at least one high Tg alkyl (meth)acrylate having a homopolymer Tg of at least 60 °C that is free of polar groups, at least one low Tg alkyl (meth)acrylate having a homopolymer Tg of less than-30 °C that is free of polar groups, at least one crosslinker, and at least one photoinitiator. The curable composition is solvent-free and inkjet printable having a viscosity of less than 25 centipoise at room temperature. Upon curing to form a coating of 100 micrometer thickness, the curable composition has a Tg of at least 50 °C as measured by DMA (Dynamic Mechanical Analysis), an adhesion to glass of less than 20 grams/inch (7.7 N/m) as measured by 180° Peel Adhesion, a Youngs modulus of greater than 0.5 GigaPascals, and is optically transparent. In some embodiments, the coating may be optically clear.

The curable coating composition may contain additional additives as long as the additives do not interfere with the coating, curing or final properties of the curable coating composition. In some embodiments, the curable coating composition further comprises at least one wetting agent additive comprising a silicone-acrylate.

The coating layer may have a variety of thicknesses. In some embodiments, the coating layer has a thickness of from 25-500 micrometers.

In some embodiments, it may be desirable to carry out the photocuring in a two-step process. In this two-step process, the first step partially cures the curable composition to raise the viscosity and helps to form a more uniform coating layer upon completion of curing. In some embodiments, the first step involves a brief exposure to UV radiation in air, and the second step is a longer curing step often carried out under a nitrogen atmosphere.

### EXAMPLES

These examples are merely for illustrative purposes only and are not meant to be limiting on the scope of the appended claims. All parts, percentages, ratios, etc. in the examples and the rest of the specification are by weight, unless noted otherwise. The following abbreviations are used: RPM=revolutions per minute; cm=centimeters; in=inches; mm=millimeters; nm=nanometers; min=minutes; s=seconds; pL=picoliters; mW=milliWatts; Hz=Hertz; and mJ=milliJoules.

Table of Abbreviations

| Abbreviation | Description | Supplicr |
|---|---|---|
| DCP | Dicyclopentanyl acrylate | Eternal(TW) |
| IBXA | Isobornyl Acrylate | Osaka Organic(JP) |
| DMA | N,N Dimethylacrylamide | Kojin(JP) |
| AA | Acrylic Acid | LG Chem(KR) |
| HEA | Hydroxyethyl Acrylate | BASF(DE) |
| EHA | 2-Ethylhexyl Acrylate | LG Chem(KR) |
| HBA | 4-Hydroxybutyl Acrylate | Osaka Organic(JP) |
| HDDA | 1,6 hexanedioldiacrylate | SK Cytec (KR) |
| PI | Photoinitiator, Bis(2,4,6- | IGM(US) |
| | Trimethylbenzoyl)phenylphosphine | |
| | oxide, available as OMNIRAD 819 | |
| SA | Surfactant, Silicone acrylate available | Evonik(DE) |
| | as TEGO RAD 2250 | |
| SL | Sodalime glass of 0.5 mm thickness, | Vitron(KR) |
| | available as FL280YF3 | |
| AB | Aluminum borosilicate glass of 0.5 | Corning(US) |
| | mm thickness, available as Eagle XG | |

### Test Methods

### Viscosity

Viscosity was measured with a Brookfield viscometer DVII+Pro with temperature control unit (25 °C), spindle #0, control RPM to a load range of 20~60%.

### Ink Jettability

Ink Jettability was determined by looking the jet drops for their shape, observing the direction and nozzle clogging by a camera located in the printer, and by testing consecutive on and off jetting performance. Samples were classified as “jettable” or “not jettable”.

### Conversion

Conversion % was measured by following the FTIR peak area ratio of the C═C bond at 810 cm-1 before and after UV cure.

### 180° Peel Adhesion

A 1 in (2.54 cm) wide sample was tested for 180° Peel at 90 in/min (228 cm/min) using an I-mass peel tester.

### Bending

The cured sample was bent to 180° to determine if the cured film breaks. Samples were classified as “Pass” if the film did not crack, and “Fail” if the film cracked.

### Tensile Measurement

Tensile strain and stress was measured according to ASTM D882 with an Instron, at a Crosshead speed of 10 mm/min. The sample dimensions were 0.1 mm thick×16 mm (Width)×50 mm (Length).

### Dynamic Mechanical Analysis

Dynamic Mechanical Analysis was used to determine the Tg. A Dynamic Mechanical Analyzer Q800 in tension mode was used and sample was scanned at 25 °C to 100 °C at 3 °C/min. The sample dimension was 0.1 mm thick×7 mm (Width)×13.5 mm (Length).

### Optical Measurements

Haze and Transmission were measured using a BYK Gardner+spectrophotometer. Color was measured using a Konica Minolta spectrophotometer CM-3700d.

### Examples E1-E4 and Comparative Examples C1-C12

A series of printable curable compositions were prepared using the components (in parts by weight) shown in Table 1. The components were mixed on a roller mixer for 24 hours at 50-100 RPM. The printable curable compositions were tested for viscosity and printability (all samples were printable), the results are shown in Table 1 below.

TABLE 1
Curable Compositions

| Ex | DCP | IBXA | DMA | AA | HEA | EHA | HBA | HDDA | PI | SA | Visc* |
|---|---|---|---|---|---|---|---|---|---|---|---|
| E1 | 0 | 75 | 0 | 0 | 0 | 25 | 0 | 25 | 1.8 | 0.007 | 5.97 |
| E2 | 0 | 75 | 0 | 0 | 0 | 25 | 0 | 20 | 1.8 | 0.007 | 4.53 |
| E3 | 0 | 75 | 0 | 0 | 0 | 25 | 0 | 15 | 1.8 | 0.007 | 4.58 |
| E4 | 0 | 75 | 0 | 0 | 0 | 25 | 0 | 10 | 1.8 | 0.007 | 4.65 |
| C1 | 0 | 65 | 0 | 0 | 20 | 0 | 35 | 25 | 1.8 | 0.007 | 6.78 |
| C2 | 0 | 65 | 0 | 0 | 20 | 0 | 35 | 20 | 1.8 | 0.007 | 6.85 |
| C3 | 0 | 65 | 0 | 0 | 20 | 0 | 35 | 15 | 1.8 | 0.007 | 7.14 |
| C4 | 0 | 65 | 0 | 0 | 20 | 0 | 35 | 10 | 1.8 | 0.007 | 7.25 |
| C5 | 65 | 0 | 0 | 0 | 0 | 20 | 0 | 30 | 1.8 | 0.007 | 5.90 |
| C6 | 65 | 0 | 0 | 0 | 0 | 20 | 0 | 20 | 1.8 | 0.007 | 5.96 |
| C7 | 65 | 0 | 0 | 0 | 0 | 20 | 0 | 15 | 1.8 | 0.007 | 5.93 |
| C8 | 65 | 0 | 0 | 0 | 0 | 20 | 0 | 10 | 1.8 | 0.007 | 6.00 |
| C9 | 0 | 60 | 20 | 0 | 0 | 0 | 0 | 20 | 1.8 | 0.007 | 3.33 |
| C10 | 0 | 60 | 20 | 0 | 0 | 0 | 0 | 15 | 1.8 | 0.007 | 3.20 |
| C11 | 0 | 60 | 20 | 0 | 0 | 0 | 0 | 10 | 1.8 | 0.007 | 3.11 |
| C12 | 0 | 75 | 0 | 5 | 0 | 0 | 0 | 20 | 1.8 | 0.007 | 4.68 |

*Viscosity at 25 °C in centipoise

The curable compositions were inkjet printed onto Sodalime glass or Aluminum borosilicate glass. The inkjet printed coatings were then cured with UV radiation. The printing and curing process is summarized below.

### Printing and Curing Process

1. Printing: Unijet inkjet printer (KR)
   Printing head: Konica Minolta KM1024i
   Nozzle jetting volume: 13 μL
   Printing frequency: 2 k Hz
   Drive voltage: 13.6V
2. Curing: UV Lamp, Phoseon FJ800 (100×100AC395-1W)
   1^{st} step: 395 nm 30 mJ (50 mW×0.6 s) in the air
   2^{nd} step: 395 nm 3000 mJ (600 mW×5 s) N₂ purged chamber-2 min

The cured compositions were tested according to the test methods shown above. The results are shown in Tables 2-4 below.

TABLE 2
Peel Adhesion from glass

| | Sodalime Glass | | | Aluminum Borosilicate Glass | | |
|---|---|---|---|---|---|---|
| | Initial | | Peel 3 | Initial | | Peel 3 |
| Example | Peel | Peel 7 days | days, 60 °C | Peel | Peel 7 days | days, 60 °C |
| E1 | 8.5 | 3.4 | 22.3 | 3.9 | 2.8 | 10.6 |
| E2 | 7.6 | 5.4 | 68.8 | <2 | — | 8.3 |
| E3 | 6.1 | 6 | — | <2 | — | 15.6 |
| E4 | 7.6 | 26.8 | — | <2 | — | 12.3 |
| C1 | 5.6 | 4.7 | — | 6.2 | 4.4 | — |
| C2 | 18.8 | 25.2 | 61.6 | <2 | — | — |
| C3 | 33.2 | 94.4 | — | <2 | — | — |
| C4 | 87 | — | — | <2 | — | — |
| C5 | 5.9 | 5.2 | — | 2.5 | 2.7 | — |
| C6 | 15.1 | 20.1 | — | <2 | — | — |
| C7 | 24 | 43.3 | — | <2 | — | — |
| C8 | 30.8 | 227 | — | <2 | — | — |
| C9 | 10.6 | 16.3 | 35 | 8.9 | 14.5 | 14.9 |
| C10 | 23.1 | 27.4 | — | 8.8 | 10 | 16.9 |
| C11 | — | — | — | 20 | 30.1 | 175 |
| C12 | 19.6 | 26.7 | — | 0.5 | 1.6 | 10.1 |

TABLE 3
Rheology Data

| | | Modulus | Modulus | | |
|---|---|---|---|---|---|
| | | (Instron) | (DMA) | Elongation | |
| Example | 180° Bend | (units) | (units) | (%) | Tg (°C) |
| E1 | F | 1643 | 1074 | 3.3 | 63.9 |
| E2 | F | 1322 | 1864 | 8.0 | 67.9 |
| E3 | F | 848 | 1583 | 10.0 | 66.0 |
| E4 | P | 788 | 1423 | 29.5 | 64.6 |
| C1 | F | 734 | 1429 | 4.6 | 63.5 |
| C2 | P | 692 | 1797 | 28.1 | 65 |
| C3 | P | 474 | 1399 | 49.6 | 59.7 |
| C4 | P | 450 | 1683 | 68.0 | 61.5 |
| C5 | F | 1278 | 1424 | 2.1 | 62.9 |
| C6 | P | 788 | 1385 | 51.3 | 60.7 |
| C7 | P | 891 | 1870 | 43.6 | 62.1 |
| C8 | P | 860 | 1317 | 65.3 | 62.2 |
| C9 | F | 1027 | 982 | 4.2 | 75.2 |
| C10 | F | 1635 | 2074 | 11.6 | 75.2 |
| C11 | P | 1449 | 1531 | 4.2 | 74.4 |
| C12 | F | 741 | 1113 | 6.7 | 72.2 |

TABLE 4
Optical Data

| | Haze | Transmission | | | |
|---|---|---|---|---|---|
| Example | (%) | (%) | Color L* | Color a* | Color b* |
| E1 | 0.07 | 93.6 | 97.16 | −0.20 | 0.43 |
| E2 | 0.15 | 93.7 | 97.13 | −0.13 | 0.34 |
| E3 | 0.08 | 93.7 | 97.18 | −0.15 | 0.34 |
| E4 | 0.23 | 93.6 | 97.08 | −0.16 | 0.43 |
| C1 | 0.16 | 93.5 | 97.14 | −0.14 | 0.33 |
| C2 | 0.06 | 93.5 | 97.09 | −0.15 | 0.40 |
| C3 | 0.23 | 93.5 | 97.13 | −0.17 | 0.48 |
| C4 | 0.11 | 93.5 | 97.13 | −0.16 | 0.40 |
| C5 | 0.05 | 93.2 | 97.11 | −0.23 | 0.46 |
| C6 | 0.14 | 93.3 | 97.06 | −0.25 | 0.60 |
| C7 | 0.18 | 93.3 | 97.02 | −0.25 | 0.65 |
| C8 | 0.23 | 93.4 | 97.02 | −0.16 | 0.42 |
| C9 | 0.29 | 93.5 | 97.14 | −0.18 | 0.43 |
| C10 | 0.15 | 93.6 | 97.17 | −0.28 | 0.58 |
| C11 | 0.16 | 93.5 | 97.18 | −0.30 | 0.54 |
| C12 | 0.08 | 94.3 | 97.16 | −0.16 | 0.37 |

What is claimed is:

1. A curable composition comprising:
at least one high Tg alkyl (meth)acrylate having a homopolymer Tg of at least 60 °C that is free of polar groups;
at least one low Tg alkyl (meth)acrylate having a homopolymer Tg of less than-30 °C that is free of polar groups;
at least one crosslinker; and
at least one photoinitiator, wherein the curable composition is solvent-free and inkjet printable having a viscosity of less than 25 centipoise at room temperature, and upon curing to form a coating of 100 micrometer thickness has a Tg of at least 50 °C as measured by DMA (Dynamic Mechanical Analysis), an adhesion to glass of less than 20 grams/inch (7.7 N/m) as measured by 180° Peel Adhesion, a Youngs modulus of greater than 0.5 GigaPascals, and is optically transparent.

2. The curable composition of claim 1, wherein the at least one high Tg alkyl (meth)acrylate comprises a compound of Formula 1,
CH₂═CR¹—(CO)—OR² Formula 1
wherein R¹ is hydrogen or a methyl group;
—(CO)— is a carbonyl group C═O; and
R² is an alkyl group comprising at least 8 carbon atoms; and is free from polar groups.

3. The curable composition of claim 1, wherein the at least one high Tg alkyl (meth)acrylate comprises a compound of Formula 1,
CH₂═CR¹—(CO)—OR² Formula 1
wherein R¹ is hydrogen or a methyl group;
—(CO)— is a carbonyl group C═O; and
R² is a cyclic alkyl group comprising at least 10 carbon atoms.

4. The curable composition of claim 1, wherein the at least one low Tg alkyl (meth)acrylate comprises a compound of Formula 2,
CH₂═CR¹—(CO)—OR³ Formula 2
wherein R¹ is hydrogen or a methyl group;
—(CO)— is a carbonyl group C═O; and
R³ is an alkyl group comprising at least 4 carbon atoms; and is free from polar groups.

5. The curable composition of claim 1, wherein the crosslinker comprises a di-(meth)acrylate of Formula 3:
CH₂═CR¹—(CO)—O—R⁴—O—(CO)—CR¹═CH₂ Formula 3
wherein R¹ is hydrogen or a methyl group;
—(CO)— is a carbonyl group C═O; and
R⁴ is an alkylene group with 4-10 carbon atoms.

6. The curable composition of claim 1, wherein the curable composition further comprises at least one wetting agent additive comprising a silicone-acrylate.

7. The curable composition of claim 1, wherein the curable composition comprises:
60-80 parts by weight of at least one high Tg alkyl (meth)acrylate having a homopolymer Tg of at least 60 °C that is free of polar groups;
20-40 parts by weight of at least one low Tg alkyl (meth)acrylate having a homopolymer Tg of less than-30 °C that is free of polar groups;
5-30 parts by weight of at least one crosslinker; and
0.1-5 parts by weight of at least one photoinitiator.

8. The curable composition of claim 8, further comprising:
0.1-1 parts by weight of at least one silicone-acrylate wetting agent.

9. An article comprising:
a substrate with a first major surface and a second major surface; and
a cured coating disposed on at least a portion of the second major surface of the substrate,
wherein the cured coating comprises a curable coating composition that has been coated and cured, the curable coating composition comprising:
at least one high Tg alkyl (meth)acrylate having a homopolymer Tg of at least 60 °C
that is free of polar groups;
at least one low Tg alkyl (meth)acrylate having a homopolymer Tg of less than-30 °C
that is free of polar groups;
at least one crosslinker; and
at least one photoinitiator, wherein the curable composition is solvent-free and inkjet printable having a viscosity of less than 25 centipoise at room temperature, and upon curing to form a coating of 100 micrometer thickness has a Tg of at least 50 °C as measured by DMA (Dynamic Mechanical Analysis), an adhesion to glass of less than 20 grams/inch (7.7 N/m) as measured by 180° Peel Adhesion, a Youngs modulus of greater than 0.5 GigaPascals, and is optically transparent.

10. The article of claim 9, wherein the substrate comprises an optically clear plate.

11. The article of claim 9, wherein the substrate comprises glass.

12. The article of claim 9, wherein the curable coating has been inkjet printed onto the second major surface of the substrate and photocured to form the cured coating.

13. The article of claim 9, wherein the curable coating composition further comprises at least one wetting agent additive comprising a silicone-acrylate.

14. The article of claim 9, wherein the cured coating has a thickness of from 25-500 micrometers.

15. A method of forming an article comprising:
providing a substrate with a first major surface and a second major surface;
providing a curable coating composition, the curable coating composition comprising:
at least one high Tg alkyl (meth)acrylate having a homopolymer Tg of at least 60 °C that is free of polar groups;
at least one low Tg alkyl (meth)acrylate having a homopolymer Tg of less than-30 °C that is free of polar groups;
at least one crosslinker; and
at least one photoinitiator, wherein the curable composition is solvent-free and inkjet printable having a viscosity of less than 25 centipoise at room temperature, and upon curing to form a coating of 100 micrometer thickness has a Tg of at least 50 °C as measured by DMA (Dynamic Mechanical Analysis), an adhesion to glass of less than 20 grams/inch (7.7 N/m) as measured by 180° Peel Adhesion, a Youngs modulus of greater than 0.5 GigaPascals, and is optically transparent;
inkjet printing the curable coating composition onto the second major surface of the substrate; and
photocuring the curable coating composition to form a coating layer on the second major surface of the substrate.

16. The method of claim 15, wherein the substrate comprises an optically clear plate.

17. The method of claim 15, wherein the substrate comprises glass.

18. The method of claim 15, wherein the curable coating composition further comprises at least one wetting agent additive comprising a silicone-acrylate.

19. The method of claim 15, wherein the coating layer has a thickness of from 25-500 micrometers.

20. The method of claim 15, wherein photocuring comprises a two-step curing process.
